(19) United States
(12) Patent Application Publication
(10) Pub. No.: US 2009/0301100 A1
(43) Pub. Date: Dec. 10, 2009

(54) Power Generation

(75) Inventor: Nello Nigro, Victoria (AU)

Correspondence Address: BRINKS HOFER GILSON & LIONE, P.O. BOX 10395, CHICAGO, IL, 60610, US

(73) Assignee: BHP BILLITON INNOVATION PTY. LTD., Melbourne, VIC (AU)

(21) Appl. No.: 12/302,977

(22) PCT Filed: Jun. 1, 2007
(86) PCT No.: PCT/AU2007/000775

§ 371 Date: Jul. 8, 2009

(30) Foreign Application Priority Data
Jun. 1, 2006 (AU) 2006902956
Jun. 1, 2006 (AU) 2006902990

(51) Int. Cl. F01K 23/08; F02C 6/00; F02C 7/22; F02D 25/00

(52) U.S. Cl. 60/780; 60/39.12; 60/772; 60/39.182; 290/4 D

(57) ABSTRACT

A method and an apparatus for generating power in a power plant with no CO₂ emissions are disclosed. The method comprises separating coal bed methane and water extracted from an underground deposit, using the coal bed methane as a source of energy for operating a gas turbine and ultimately generating electricity, in a power plant and using the water in the power plant, for example in a cooling water circuit of the power plant. The method includes separately or in combination supplying steam to a combustor of the gas turbine.

The present invention relates to a method and an apparatus for generating electrical power that is based on the use of coal bed methane gas as a source of energy for driving a gas turbine and a steam turbine for generating the power.

The term “coal bed methane” is understood herein to mean gas that contains at least 75% methane gas on a volume basis obtained from an underground coal source.

International application PCT/AU2004/001339 (WO 2005/5031136) in the name of the applicant describes and claims a method of generating power via a gas turbine and a steam turbine in a power plant which comprises operating in a first mode by:
(a) supplying coal bed methane, an oxygen-containing gas, and flue gas produced in the gas turbine, all under pressure, to a combustor of the gas turbine and combusting the coal bed methane and using the heated combustion products and the flue gas to drive the gas turbine;
(b) supplying a hot flue gas stream produced in the gas turbine to a heat recovery steam generator and using the heat of the flue gas to generate steam by way of heat exchange with water supplied to the steam generator;
(c) suppling steam from the steam generator to a steam turbine and using the steam to drive the steam turbine; and
(d) supplying (i) a part of the flue gas stream from the gas turbine that passes through the heat recovery steam generator to the combustor of the gas turbine and (ii) another part of the flue gas stream from the gas turbine that passes through the heat recovery steam generator to a suitable underground storage region.

The International application also discloses operating in a second mode by:
(a) supplying coal bed methane and air from an air compressor of the gas turbine, both under pressure, to the combustor of the gas turbine and combusting the coal bed methane and using the heated combustion products and the flue gas to drive the gas turbine;
(b) supplying a hot flue gas stream produced in the gas turbine to the heat recovery steam generator and using the heat of the flue gas to generate steam by way of heat exchange with water supplied to the steam generator; and
(c) supplying steam from the steam generator to the steam turbine and using the steam to drive the steam turbine.

The International application also discloses an apparatus for generating power.

The disclosure in the International application is incorporated herein by cross reference.

One of the features of the method described and claimed in the International application is that it can operate with no CO₂ emissions into the atmosphere. By way of example, by operating the first operating mode of the method so that step (d)(ii) supplies all of the flue gas, which inevitably contains substantial amounts of CO₂, that is not supplied to the combustor of the gas turbine to the suitable underground storage is an effective option for preventing CO₂ emissions into the atmosphere that does not have any adverse environmental consequences.

Another feature of the method described and claimed in the International application is that the use of part of the flue gas stream from the gas turbine in the combustor of the gas turbine in step (d)(i) of the first operating mode of the method makes it possible to reduce, and preferably replace altogether, the use of air in the combustor of the gas turbine. The total replacement of air with oxygen and flue gas, which is predominantly CO₂ in this mode of operation, overcomes significant issues in relation to the use of air. For example, the use of air means that the flue gas stream from the gas turbine contains a significant amount (typically at least 70 vol. %) nitrogen, an amount (typically 10 vol. %) oxygen, and an amount (typically 5-10 vol. %) CO₂. The mixture of nitrogen, oxygen, and CO₂ presents significant gas separation issues in order to process the flue gas stream properly. The replacement of air with oxygen and flue gas in this mode of operation means that the flue gas stream from the heat recovery steam generator is predominantly CO₂ and water and greatly simplifies the processing requirements for the flue gas from the gas turbine, with the result that it is a comparatively straightforward exercise to produce a predominately CO₂ flue gas stream and supply the stream to the combustor of the gas turbine.

Typically, coal bed methane is extracted from underground coal deposits located in remote areas, i.e. areas that are well away from substantial population centres and, therefore, it is necessary to transport the coal bed methane to the population centres to use the coal bed methane.

Coal bed methane contains water, typically in an atomised form. The current industry practice is to condense water from coal bed methane after extraction from an underground deposit and thereafter transport the dewatered coal bed methane to population centres.

The water in coal bed methane has high salinity and high total dissolved solids and, consequently, has limited (if any) uses at the remote locations from which it is extracted. Purifying the water, for example by reverse osmosis, to make the water potable and thereafter transporting the water to population centres is also not a commercially acceptable option. Accordingly, the current practice is to transfer the water to solar ponds to evaporate in the ponds. This represents a substantial waste of water, typically or the order of millions of litres per day.

The applicant has realised that the method and apparatus described and claimed in the International application and, in particular operation with no CO₂ emissions by returning flue gas to an underground storage or recycling CO₂ through the process, is a significant driver to locate electrical power stations proximate deposits of coal bed methane.

The applicant has also realised that locating electrical power stations proximate deposits of coal bed methane provides an opportunity to use water separated from coal bed methane beneficially in the power stations, for example as make-up water and/or as cooling water, and thereby reduce the operating costs of the power stations. By way of example, it is relevant to note that substantial volumes of water are separated from coal bed methane and substantial volumes of water are required on a daily basis in power stations. This realisation is the basis of a first aspect of the present invention.

The applicant has also realised that further advantages are possible by modifying the method and the apparatus described and claimed in the International application to include supplying steam to the combustor of the gas turbine. This realisation is the basis of a second aspect of the present invention.

In general terms, according to the first aspect of the present invention there is provided a method of generating power in a power plant which comprises: separating coal bed methane and water extracted from an underground deposit, using the coal bed methane as a source of energy for operating a gas turbine and ultimately generating electricity in the power plant, and using the water in the power plant, for example in a cooling water circuit of the power plant.

In more specific terms, according to the first aspect of the present invention there is provided a method of generating power via a gas turbine and a steam turbine in a power plant which comprises operating in a first mode by:
(a) separating coal bed methane and water extracted from an underground deposit,
(b) supplying coal bed methane from step (a) and an oxygen-containing gas, both under pressure, to a combustor of the gas turbine and combusting the coal bed methane and using the heated combustion products to drive the gas turbine;
(c) supplying a hot flue gas stream produced in the gas turbine to a heat recovery steam generator and using the heat of the flue gas to generate steam by way of heat exchange with water supplied to the steam generator;
(d) suppling steam from the steam generator to a steam turbine and using the steam to drive the steam turbine;
(e) supplying (i) a part of the flue gas stream from the gas turbine that passes through the heat recovery steam generator to the combustor of the gas turbine and (ii) another part of the flue gas stream from the gas turbine that passes through the heat recovery steam generator to a suitable underground storage region; and
(f) supplying at least a part of the water dewatered from coal bed methane in step (a) for use in the power plant, for example in a cooling circuit of the power plant.

Preferably the method includes treating the water dewatered from coal bed methane in step (a) to at least partially reduce the salinity and/or total dissolved solids of the water.

Preferably step (f) includes supplying at least a part of the water dewatered from coal bed methane in step (a) for use as make-up water in the heat recovery steam generator.

Preferably the method includes supplying a part of a flue gas produced in the gas turbine, under pressure, to the combustor of the gas turbine in step (b).

Preferably the method includes supplying high pressure steam produced in the steam generator in step (c), under pressure, to the combustor of the gas turbine in step (b).

Preferably the oxygen-containing gas supplied to the combustor of the gas turbine in step (b) is oxygen-enriched air.

More preferably the oxygen-containing gas supplied to the combustor of the gas turbine in step (b) is oxygen.

Preferably the method includes supplying compressed air from an air compressor of the gas turbine to an oxygen plant and producing oxygen gas for step (b).

Preferably the flue gas stream supplied to the combustor of the gas turbine in step (b) is predominantly CO₂.

Preferably step (e) includes supplying part of the flue gas stream to the combustor of the gas turbine and the remainder of the flue gas stream to the underground storage.

Preferably step (e) includes supplying the flue gas stream to the underground storage region as a liquid phase.

Preferably the underground storage region is a coal bed seam.

More preferably the underground storage region is the coal bed seam from which coal bed methane to power the gas turbine is extracted. In this context, the existing well structures for extracting coal bed methane can be used to transfer flue gas, in liquid or gas phases, to the underground storage region.

Preferably step (e) includes supplying the flue gas stream to the underground storage region via existing well structures for extracting coal bed methane from the underground storage region.

Preferably step (e) includes separating water from the flue gas.

Step (e) may further include:
(i) compressing the flue gas stream to a first pressure (typically 15-30 bar, preferably 15-30 bar); and
(ii) supplying one part of the compressed flue gas stream to the combustor of the gas turbine.

Step (e) may further include:
(i) compressing another part of the compressed flue gas stream to a second, higher pressure (typically at least 70 bar, more typically at least 73 bar);
(ii) cooling the pressurised flue gas stream from step (i) and forming a liquid phase; and
(iii) supplying the liquid phase to the underground storage region.

Preferably the method includes operating in a second mode as an alternative to the first mode by:
(a) supplying coal bed methane and air from an air compressor of the gas turbine, both under pressure, to the combustor of the gas turbine and combusting the coal bed methane and using the heated combustion products and the flue gas to drive the gas turbine;
(b) supplying a hot flue gas stream produced in the gas turbine to the heat recovery steam generator and using the heat of the flue gas to generate steam by way of heat exchange with water supplied to the steam generator; and
(c) supplying steam from the steam generator to the steam turbine and using the steam to drive the steam turbine.

In general terms, according to the first aspect of the present invention there is also provided an apparatus for generating power in a power plant which comprises: a means for separating coal bed methane and water from an underground deposit, a gas turbine that is operable with coal bed methane produced in the coal bed methane/water separation means, and a cooling water circuit that is operable with water produced in the coal bed methane/water separation means.

In more specific terms, according to the first aspect of the present invention there is also provided an apparatus for generating power which comprises:
(a) a separator for separating coal bed methane and water extracted from an underground deposit;
(b) a gas turbine having an air compressor, an air expander, and a combustor;
(c) an air separation plant for producing oxygen;
(d) a system for supplying the following feed materials to the combustor of the gas turbine: coal bed methane, oxygen from the air separation plant, air from the air compressor of the gas turbine, and flue gas produced in the gas turbine, all under pressure, for combusting the coal bed methane and using the heated combustion products and the flue gas to drive the gas turbine;
(e) a heat recovery steam generator for generating steam from water supplied to the steam generator by way of heat exchange with a flue gas from the gas turbine;
(f) a steam turbine adapted to be driven by steam generated in the steam generator;
(g) a system for supplying (i) one part of a flue gas stream from the gas turbine that passes through the heat recovery steam generator to the combustor of the gas turbine and (ii) another part of the flue gas stream from the gas turbine that passes through the heat recovery steam generator to a suitable underground storage region when the apparatus is operating with coal bed methane, oxygen from the air separation plant, and flue gas produced in the gas turbine being supplied to the combustor of the gas turbine; and
(h) a cooling circuit for one or more than one of the above-mentioned unit operations of the power plant that is operable at least in part with water produced in the coal bed methane/water separation means.

According to the second aspect of the present invention there is provided a method of generating power via a gas turbine and a steam turbine which comprises operating in a first mode by:
(a) supplying coal bed methane, an oxygen-containing gas, steam, and flue gas produced in the gas turbine, all under pressure, to a combustor of the gas turbine and combusting the coal bed methane and using the heated combustion products and the flue gas to drive the gas turbine;
(b) supplying a hot flue gas stream produced in the gas turbine to a heat recovery steam generator and using the heat of the flue gas to generate steam by way of heat exchange with water supplied to the steam generator;
(c) suppling at least a part of the steam from the steam generator to a steam turbine and using the steam to drive the steam turbine; and
(d) supplying (i) a part of the flue gas stream from the gas turbine that passes through the heat recovery steam generator to the combustor of the gas turbine and (ii) another part of the flue gas stream from the gas turbine that passes through the heat recovery steam generator to a suitable underground storage region.

One advantage of supplying steam to the gas turbine in step (a) is that it reduces the dependency of the method on supplying flue gas to the gas turbine to maintain mass flow rate through the gas turbine.

Another advantage of supplying steam to the combustor of the gas turbine in step (a) is that it reduces power requirements to compress flue gas for the gas turbine.

Preferably the steam supplied to the combustor of the gas turbine in step (a) is at least a part of the steam generated in the heat recovery steam generator in step (b).

Preferably steam supplied to the combustor of the gas turbine in step (a) is at a pressure of 15-30 bar.

Preferably the method includes supplying a part of a flue gas produced in the gas turbine, under pressure, to the combustor of the gas turbine in step (a).

Preferably the oxygen-containing gas supplied to the combustor of the gas turbine in step (a) is oxygen-enriched air.

More preferably the oxygen-containing gas supplied to the combustor of the gas turbine in step (a) is oxygen.

Preferably the flue gas stream supplied to the combustor of the gas turbine in step (a) is predominantly CO₂.

Preferably the method includes supplying compressed air from an air compressor of the gas turbine to an oxygen plant and producing oxygen-containing gas for step (a).

Preferably step (d) includes supplying a part of the flue gas stream to the combustor of the gas turbine and the remainder of the flue gas stream to the underground storage.

Preferably step (d) includes supplying the flue gas stream to the underground storage region as a liquid phase.

Preferably the underground storage region is a coal bed seam.

More preferably the underground storage region is the coal bed seam from which coal bed methane to power the gas turbine is extracted. In this context, the existing well structures for extracting coal bed methane can be used to transfer flue gas, in liquid or gas phases, to the underground storage region.

Preferably step (d) includes supplying the flue gas stream to the underground storage region via existing well structures for extracting coal bed methane from the underground storage region.

Preferably step (d) includes separating water from the flue gas.

Step (d) may further include:
(i) compressing the flue gas stream to a first pressure (typically 20-30 bar); and
(ii) supplying one part of the compressed flue gas stream to the combustor of the gas turbine.

Step (d) may further include:
(i) compressing another part of the compressed flue gas stream to a second, higher pressure (typically at least 70 bar, more typically at least 73 bar);
(ii) cooling the pressurised flue gas stream from step (i) and forming a liquid phase; and
(iii) supplying the liquid phase to the underground storage region.

Preferably the method includes operating in a second mode as an alternative to the first mode by:
(a) supplying coal bed methane and air from an air compressor of the gas turbine, both under pressure, to the combustor of the gas turbine and combusting the coal bed methane and using the heated combustion products and the flue gas to drive the gas turbine;
(b) supplying a hot flue gas stream produced in the gas turbine to the heat recovery steam generator and using the heat of the flue gas to generate steam by way of heat exchange with water supplied to the steam generator; and
(c) supplying steam from the steam generator to the steam turbine and using the steam to drive the steam turbine.

According to the second aspect of the present invention there is also provided an apparatus for generating power which comprises:
(a) a gas turbine having an air compressor, an air expander, and a combustor;
(b) an air separation plant for producing oxygen;
(c) a system for supplying the following feed materials to the combustor of the gas turbine: coal bed methane, oxygen from the air separation plant, air from the air compressor of the gas turbine, steam, and flue gas produced in the gas turbine, all under pressure, for combusting the coal bed methane and using the heated combustion products and the flue gas to drive the gas turbine;
(d) a heat recovery steam generator for generating steam from water supplied to the steam generator by way of heat exchange with a flue gas from the gas turbine;
(e) a steam turbine adapted to be driven by at least a part of the steam generated in the steam generator; and
(f) a system for supplying (i) a part of a flue gas stream from the gas turbine that passes through the heat recovery steam generator to the combustor of the gas turbine and (ii) another part of the flue gas stream from the gas turbine that passes through the heat recovery steam generator to a suitable underground storage region when the apparatus is operating with coal bed methane, oxygen from the air separation plant, and flue gas produced in the gas turbine being supplied to the combustor of the gas turbine.

Preferably the apparatus includes a system for supplying a part of the steam generated in the steam generator to the combustor of the gas turbine.

The present invention is described further with reference to the accompanying drawing which is one, although not the only, embodiment of a power generation method and power generation apparatus of the invention.

With reference to the figure, the method includes separating coal bed methane and water that are extracted together from an underground source 3 in a condenser or other suitable separation means 71 into two separate product streams, namely coal bed methane and water.

The water from the condenser 71 is supplied via a line 75 for use in one or more than one unit operation in the power generation apparatus shown in the figure. One application is in a cooling water circuit (not shown) of the apparatus. The cooling water circuits include, by way of example, one or more than one water cooling tower in which the water is used as make-up water. Another application is as make-up water in a heat recovery steam generator 27, described hereinafter.

In situations where the typically high salinity and typically high total dissolved solids of the water is an issue, the method includes treating the water from the condenser 71 to lower the salinity and TDS levels, for example by passing the water through a reverse osmosis unit, before using the water in the cooling water circuit

The method further includes supplying the following gas streams to a combustor 5 of a gas turbine generally identified by the numeral 7:
(a) coal bed methane from the condenser 71 via a dedicated coal bed methane compressor station (not shown) and a supply line 51;
(b) oxygen, in an amount required for stoichiometric combustion, produced in an oxygen plant in the form of an air separation plant 11, via a line 53;
(c) high pressure steam that has been supplied from the heat recovery steam generator 27, described hereinafter, via a line 63; and
(d) flue gas, which is predominantly CO₂, that has been supplied from a flue gas stream from the turbine 7, described hereinafter, via a line 55.

The streams of oxygen, steam, and flue gas are pre-mixed in a mixer 9 upstream of the combustor 5.

The stream of coal bed methane and the stream of oxygen/steam/flue gas are supplied to the combustor 5 at a preselected pressure of between 15 and 30 bar. It is noted that the combustor 5 may operate with any suitable pressure.

The coal bed methane is combusted in the combustor 5 and the products of combustion and the flue gas supplied to the combustor 5 are delivered to an expander 13 of the turbine 7 and drive the turbine blades (not shown) located in the expander 13.

The output of the turbine 7 is connected to and drives an electrical generator 15 and a multiple stage flue gas compressor train 17.

When the power generation method is operating in the above-described mode, air in the air compressor 21 of the turbine 7 is bled at approximately 5 bar pressure and delivered to the air separation plant and is used to produce oxygen for the combustor 5 of the gas turbine 7.

The output gas stream, ie the flue gas, from the turbine 7 is at atmospheric pressure and typically at a temperature of the order of 540° C.

The flue gas from the turbine 7 is passed through the heat recovery steam generator 27 and is used as a heat source for producing high pressure steam, typically approximately 75 bar or 7.5 Mpa, from a stream of demineralised water and condensate return supplied to the steam generator 27.

A part of the high pressure steam is supplied via the line 63 to the combustor 5 of the gas turbine 7, as described above.

Another part of the high pressure steam is supplied via a line 57 to a steam turbogenerator 29 and is used to run the turbogenerator 29 and generate electrical power.

A further part of the high pressure steam is supplied via a line 61 to the air separation plant 11 to generate oxygen for the combustor 5 of the gas turbine 7.

The flue gas from the heat recovery steam generator 27, which is predominantly CO₂ and water, leaves the steam generator as a wet flue gas stream, typically at a temperature of 125° C., via an outlet 19.

The wet flue gas is then passed through a water separator 33 that separates water from the stream and produces a dry flue gas stream.

The dry flue gas stream is then passed through the multiple (in this case two) stage flue gas compressor train 17.

In a first stage of compression, marked “Stage 1” in the figure, the flue gas is compressed to the necessary pressure, namely between 15 and 30 bar, typically 22 bar in the present instance, for the combustor 5 of the turbine 7.

A part of the compressed flue gas from the exit of the first stage is supplied to the combustor 5 of the turbine 7 via the mixer 9, typically a mix valve, and mixes with oxygen from the air separator 11 prior to being supplied to the combustor 5.

The remainder of the compressed flue gas from the first stage, which is predominantly CO₂ and water, is supplied to the second compression stage, marked “Stage 2” in the figure, via a condenser 59 and a water separator 61. The flue gas is compressed to a higher pressure, typically above 70 bar, preferably above 73 bar, and the stream of compressed flue gas is then passed through a condenser 35. The condenser 35 cools the temperature of the flue gas stream to below 31° C. and thereby converts the flue gas to a liquid phase.

The liquid flue gas stream leaving the condenser is pressurised (if necessary) and then injected into existing field wells.

When the power generation system is not operating in the above-described mode and, more particularly is not receiving the stream of pre-mixed oxygen and flue gas, the turbine 7 operates on a conventional basis with air being drawn through the turbine air intake (not shown) and compressed in the air compressor 21 and thereafter delivered to the combustor 5 and mixed with coal bed methane and the mixture combusted in the combustor 5.

More particularly, the option of operating on a more conventional basis is available by disconnecting the multiple stage flue gas compressor train 17 from the turbine 7.

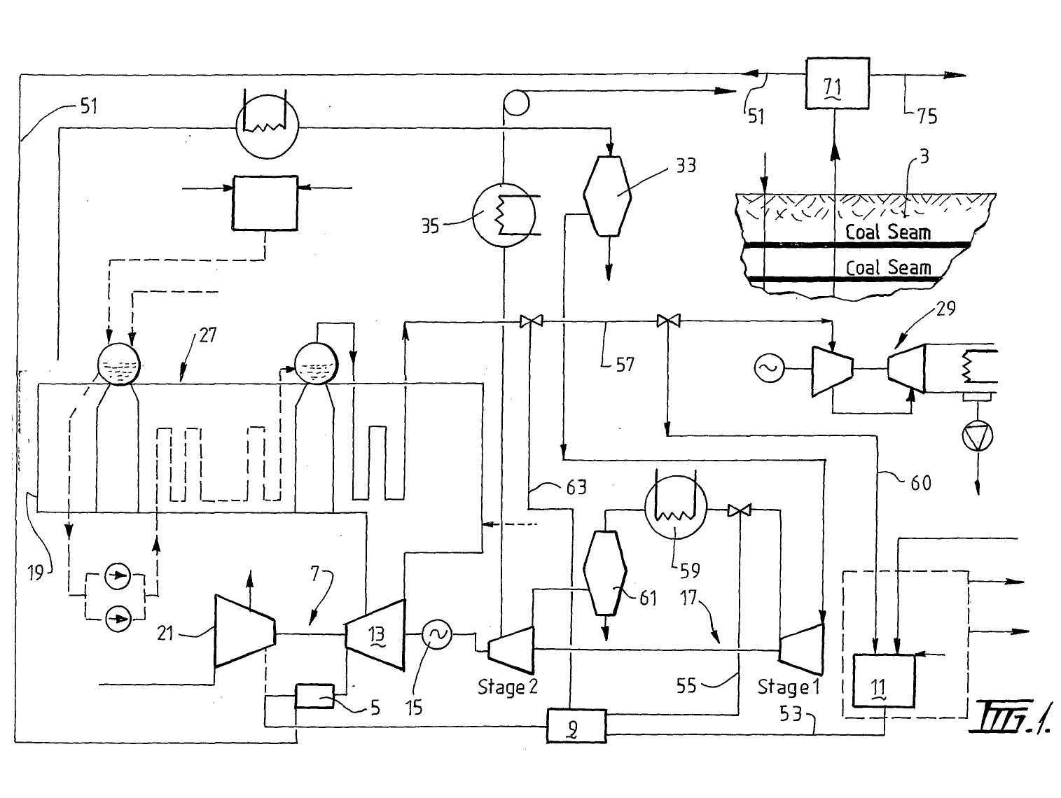

The key components of the above-described embodiment of the process and the apparatus of the invention shown in the figure are as follows:
(a) Air Separation Plant 11—This unit is required to produce oxygen for combustion of coal bed methane in the turbine combustor. Typically, the plant is a standard off-the-shelf unit sized to cope with the O₂ required for complete combustion of coal bed methane.
(b) Gas Turbine/Generator 7—Typically, this unit is a standard gas turbine fitted with a standard combustor. The multi-stage flue gas compressor 17 will be fitted on the same shaft with a clutch unit that will enable the compressor to be isolated when the turbine is operating in a conventional manner. The attachment of large multi-stage compressors to gas turbine units is quite common in the steel industry where low Btu steelworks gases are compressed by these units before being delivered to the combustor for combustion.
(c) Heat Recovery Steam Generator 27—Typically, this unit is a standard double pressure unfired unit.
(d) Steam Turbine/Generator 29—Typically, this unit, complete with the steam cycle ancillaries, is a standard steam turbine unit.
(e) Flue Gas Recirculating and CO₂ Underground storage System—Typically, this system contains the following:
   (i) Water Separator/knockout Unit—Typically this unit is a simple water separation plant in which water is knocked out of the flue gas stream prior it entering the multi-stage compressor unit.
   (ii) CO₂ multi-stage compressor train 17—For the embodiment shown in FIG. 1, typically this unit is designed to handle the entire flue gas stream in the first stage of compression and the smaller stream of flue gas for underground storage. Typically, this smaller stream will be pressurised to above 70 bar, preferably above 73 bar, before being delivered to the condenser.
   (iii) Condenser 35—This unit is required to produce liquid flue gas, which is predominantly CO₂, prior to injecting it to underground wells.

Many modifications may be made to the embodiment of the present invention described above with reference to the figure without departing from the spirit and scope of the invention.

By way of example, in another, although not the only other possible, embodiment of the method and the apparatus of the invention, the flue gas from the steam generator 27 is passed through a recuperator (not shown) and is cooled to a temperature, typically 80° C., before being transferred to the water separator 33. In addition, the dry flue gas is not split into two streams after the first stage in the multiple stage flue gas compressor train 17, as is the case in the embodiment shown in the figure. Rather, the whole of the dry flue gas from the water separator 33 is compressed in the compressor train 17 and then passed through the condenser 35. The liquid stream from the condenser 35 is then split into two streams, with one stream being supplied to the underground storage region and the other stream being passed through the recuperator and being converted into a gas phase via heat exchange with the flue gas stream from the steam generator 27. The reformed flue gas from the recuperator is then supplied to the combustor 5 via the mixer 9.

In addition, whilst the embodiment of the present invention described above with reference to the figure supplies flue gas, which is predominantly CO₂ , in a liquid form to an underground coal bed seam, the present invention is not so limited and extends to supplying flue gas to any other suitable underground storage region.

In addition, whilst the embodiment of the present invention described above with reference to the figure supplies flue gas, which is predominantly CO₂ , in a liquid form to an underground coal bed seam, the present invention is not so limited and extends to supplying flue gas in a gaseous form to a coal bed seam or any other suitable underground storage region.

1.-28. (canceled)

29. A method of generating power via a gas turbine and a steam turbine in a power plant which comprises operating in a first mode by:
(a) separating coal bed methane and water extracted from an underground deposit,
(b) supplying coal bed methane from step (a) and an oxygen-containing gas, both under pressure, to a combustor of the gas turbine and combusting the coal bed methane and using the heated combustion products to drive the gas turbine;
(c) supplying a hot flue gas stream produced in the gas turbine to a heat recovery steam generator and using the heat of the flue gas to generate steam by way of heat exchange with water supplied to the steam generator;
(d) suppling steam from the steam generator to a steam turbine and using the steam to drive the steam turbine;
(e) supplying (i) a part of the flue gas stream from the gas turbine that passes through the heat recovery steam generator to the combustor of the gas turbine and (ii) another part of the flue gas stream from the gas turbine that passes through the heat recovery steam generator to a suitable underground storage region; and
(f) supplying at least a part of the water from step (a) for use in the power plant.

30. The method defined in claim 29 further including treating the water in step (a) to at least partially reduce at least one of a salinity and total dissolved solids of the water.

31. The method defined in claim 29 wherein step (f) includes supplying at least a part of the water from step (a) for use as make-up water in the heat recovery steam generator.

32. The method defined in claim 29 further including supplying a part of a flue gas produced in the gas turbine, under pressure, to the combustor of the gas turbine in step (b).

33. The method defined in claim 29 further including supplying high pressure steam produced in the steam generator in step (c), under pressure, to the combustor of the gas turbine in step (b).

34. The method defined in claim 29 wherein the oxygen-containing gas supplied to the combustor of the gas turbine in step (b) is oxygen-enriched air.

35. The method defined in claim 29 wherein the oxygen-containing gas supplied to the combustor of the gas turbine in step (b) is oxygen.

36. The method defined in claim 29 further including supplying compressed air from an air compressor of the gas turbine to an oxygen plant and producing oxygen gas for step (b).

37. The method defined in claim 32 wherein the flue gas stream supplied to the combustor of the gas turbine in step (b) is predominantly CO2.

38. The method defined in claim 29 wherein step (e) includes separating water from the flue gas.

39. The method defined in claim 38 wherein step (e) further includes:
(i) compressing the flue gas stream to a first pressure; and
(ii) supplying one part of the compressed flue gas stream to the combustor of the gas turbine.

40. The method defined in claim 39 wherein step (e) further includes:
(i) compressing another part of the compressed flue gas stream to a second pressure that is higher than the first pressure;
(ii) cooling the pressurised flue gas stream from step (i) and forming a liquid phase; and
(iii) supplying the liquid phase to the underground storage region.

41. A method of generating power in a power plant that comprises separating coal bed methane and water extracted from an underground deposit, using the coal bed methane as a source of energy for operating a gas turbine and generating electricity in the power plant, and using the water in the power plant.

42. An apparatus for generating power that comprises:
(a) a separator for separating coal bed methane and water extracted from an underground deposit;
(b) a gas turbine having an air compressor, an air expander, and a combustor;
(c) an air separation plant for producing oxygen;
(d) a system for supplying the following feed materials to the combustor of the gas turbine: coal bed methane, oxygen from the air separation plant, air from the air compressor of the gas turbine, and flue gas produced in the gas turbine, all under pressure, for combusting the coal bed methane and using heated combustion products from the combustor and flue gas to drive the gas turbine;
(e) a heat recovery steam generator for generating steam from water supplied to the steam generator by way of heat exchange with the flue gas from the gas turbine;
(f) a steam turbine adapted to be driven by steam generated in the steam generator;
(g) a system for supplying (i) one part of the flue gas stream from the gas turbine that passes through the heat recovery steam generator to the combustor of the gas turbine and (ii) another part of the flue gas stream from the gas turbine that passes through the heat recovery steam generator to a suitable underground storage region when the apparatus is operating with coal bed methane, oxygen from the air separation plant, and flue gas produced in the gas turbine being supplied to the combustor of the gas turbine; and
(h) a cooling circuit for one or more than one of the above-mentioned unit operations of the power plant that is operable at least in part with water produced in the coal bed methane and water separator.

43. An apparatus for generating power in a power plant which comprises: a methane/water separator to separate coal bed methane and water from an underground deposit, a gas turbine that is operable with coal bed methane produced in the methane/water separator, and a cooling water circuit that is operable with water produced in the methane/water separator.

44. A method of generating power via a gas turbine and a steam turbine which comprises operating in a first mode by:
(a) supplying coal bed methane, an oxygen-containing gas, steam, and flue gas produced in the gas turbine, all under pressure, to a combustor of the gas turbine and combusting the coal bed methane and using heated combustion products from the combustor and the flue gas to drive the gas turbine;
(b) supplying a hot flue gas stream produced in the gas turbine to a heat recovery steam generator and using a heat of the flue gas to generate steam by way of heat exchange with water supplied to the steam generator;
(c) supplying at least a part of the steam from the steam generator to a steam turbine and using the steam to drive the steam turbine; and
(d) supplying (i) a part of a flue gas stream from the gas turbine that passes through the heat recovery steam generator to the combustor of the gas turbine and (ii) another part of the flue gas stream from the gas turbine that passes through the heat recovery steam generator to a suitable underground storage region.

45. The method defined in claim 44 wherein the steam supplied to the combustor of the gas turbine in step (a) includes at least a part of the steam generated in the heat recovery steam generator in step (b).

46. The method defined in claim 44 wherein the steam supplied to the combustor of the gas turbine in step (a) is at a pressure of about 15 to about 30 bar.

47. The method defined in claim 44 further including supplying a part of a flue gas produced in the gas turbine, under pressure, to the combustor of the gas turbine in step (a).

48. The method defined in claim 44 wherein the oxygen-containing gas supplied to the combustor of the gas turbine in step (a) is oxygen-enriched air.

49. The method defined in claim 44 wherein the oxygen-containing gas supplied to the combustor of the gas turbine in step (a) is oxygen.

50. The method defined in claim 44 wherein the flue gas stream supplied to the combustor of the gas turbine in step (a) is predominantly CO₂.

51. The method defined in claim 44 further including supplying compressed air from an air compressor of the gas turbine to an oxygen plant and producing oxygen-containing gas for step (a).

52. The method defined in claim 44 wherein step (d) includes separating water from the flue gas.

53. The method defined in claim 52 wherein step (d) further includes:
(i) compressing the flue gas stream to a first pressure; and
(ii) supplying one part of the compressed flue gas stream to the combustor of the gas turbine.

54. The method defined in claim 53 wherein step (d) further includes:
(i) compressing another part of the compressed flue gas stream to a second pressure that is higher than the first pressure;
(ii) cooling the pressurised flue gas stream from step (i) and forming a liquid phase; and
(iii) supplying the liquid phase to the underground storage region.

55. An apparatus for generating power comprising:
(a) a gas turbine having an air compressor, an air expander, and a combustor;
(b) an air separation plant for producing oxygen;
(c) a system for supplying the following feed materials to the combustor of the gas turbine: coal bed methane, oxygen from the air separation plant, air from the air compressor of the gas turbine, steam, and flue gas produced in the gas turbine, all under pressure, for combusting the coal bed methane and using the heated combustion products and the flue gas to drive the gas turbine;
(d) a heat recovery steam generator for generating steam from water supplied to the steam generator by way of heat exchange with flue gas from the gas turbine;
(e) a steam turbine adapted to be driven by at least a part of the steam generated in the steam generator; and
(f) a system for supplying (i) a part of a flue gas stream from the gas turbine that passes through the heat recovery steam generator to the combustor of the gas turbine and (ii) another part of the flue gas stream from the gas turbine that passes through the heat recovery steam generator to a suitable underground storage region when the apparatus is operating with coal bed methane, oxygen from the air separation plant, and flue gas produced in the gas turbine being supplied to the combustor of the gas turbine.

56. The apparatus defined in claim 55 further including a means for supplying a part of the steam generated in the steam generator to the combustor of the gas turbine.
